(19) United States
(12) Patent Application Publication
(10) Pub. No.: US 2026/0221010 A1
(43) Pub. Date: Jul. 30, 2026

(54) SAFETY AUDIO ERROR DETECTION

(71) Applicant: QUALCOMM Incorporated, San Diego, CA (US)

(72) Inventors: Mayur NIRMAL, Bangalore (IN); Basavaraja MAGANAHALLI, Bengaluru (IN); Chun WANG, Markham (CA); Sanjay GUPTA, North York (CA); Santosh THOMAS, Bangalore (IN)

(21) Appl. No.: 19/038,040

(22) Filed: Jan. 27, 2025

(51) Int. Cl. G08B 3/00

(52) U.S. Cl. CPC G08B 3/00

(57) ABSTRACT

A device includes a memory configured to store first audio data and second audio data. The first audio data corresponds to a safety alert. The device also includes one or more processors coupled to the memory. The one or more processors are configured to obtain audio samples that are based on buffered audio samples added to an audio buffer. The obtained audio samples include first audio samples interleaved with second audio samples. The first audio samples are based on the first audio data. The second audio samples are based on the second audio data. The one or more processors are also configured to extract the first audio samples from the obtained audio samples based on an audio sample position configuration associated with the first audio data. The one or more processors are also configured to generate an error output based on the extracted first audio samples.

### I. FIELD

The present disclosure is generally related to safety audio error detection.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices can incorporate functionality to output vehicle safety audio, such as a pedestrian detection warning, collision warning, over-speed warning, etc. A safety audio stream is typically interleaved with an infotainment audio stream and transmitted via an audio interface to a speaker pad for playout. The safety audio stream can be compromised for various reasons, e.g., hardware malfunction, pad level electrical issues, electromagnetic interference, etc.

### III. SUMMARY

According to one implementation of the present disclosure, a device includes a memory configured to store first audio data and second audio data. The first audio data corresponds to a safety alert. The device also includes one or more processors coupled to the memory. The one or more processors are configured to obtain audio samples that are based on buffered audio samples added to an audio buffer. The obtained audio samples include first audio samples interleaved with second audio samples. The first audio samples are based on the first audio data. The second audio samples are based on the second audio data. The one or more processors are also configured to extract the first audio samples from the obtained audio samples based on an audio sample position configuration associated with the first audio data. The one or more processors are further configured to generate an error output based on the extracted first audio samples.

According to another implementation of the present disclosure, a method includes obtaining, at a device, audio samples that are based on buffered audio samples added to an audio buffer. The obtained audio samples include first audio samples interleaved with second audio samples. The first audio samples are based on first audio data corresponding to a safety alert. The second audio samples are based on second audio data. The method also includes extracting, at the device, the first audio samples from the obtained audio samples based on an audio sample position configuration associated with the first audio data. The method also includes generating, at the device, an error output based on the extracted first audio samples.

According to another implementation of the present disclosure, a non-transitory computer-readable medium includes instructions that, when executed by one or more processors, cause the one or more processors to obtain audio samples that are based on buffered audio samples added to an audio buffer. The obtained audio samples include first audio samples interleaved with second audio samples. The first audio samples are based on first audio data corresponding to a safety alert. The second audio samples are based on second audio data. The instructions also cause the one or more processors to extract the first audio samples from the obtained audio samples based on an audio sample position configuration associated with the first audio data. The instructions further cause the one or more processors to generate an error output based on the extracted first audio samples.

According to another implementation of the present disclosure, an apparatus includes means for obtaining audio samples that are based on buffered audio samples added to an audio buffer. The obtained audio samples include first audio samples interleaved with second audio samples. The first audio samples are based on first audio data corresponding to a safety alert. The second audio samples are based on second audio data. The apparatus also includes means for extracting the first audio samples from the obtained audio samples based on an audio sample position configuration associated with the first audio data. The apparatus further includes means for generating an error output based on the extracted first audio samples.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a device operable to perform safety audio error detection, in accordance with some examples of the present disclosure.

FIG. 2 is a diagram of an illustrative aspect of operations associated with safety audio error detection, in accordance with some examples of the present disclosure.

FIG. 3 is a diagram of an illustrative example of audio frames and registers storing bitmasks that can be used to extract safety audio from the audio frames, in accordance with some examples of the present disclosure.

FIG. 4 is a timing diagram of an illustrative aspect of operations associated with safety audio error detection, in accordance with some examples of the present disclosure.

FIG. 5 is a diagram of an illustrative aspect of operations associated with safety audio error detection, in accordance with some examples of the present disclosure.

FIG. 6 illustrates an example of an integrated circuit operable to perform safety audio error detection, in accordance with some examples of the present disclosure.

FIG. 7 is a diagram of an example of a vehicle operable to perform safety audio error detection, in accordance with some examples of the present disclosure.

FIG. 8 is a diagram of a particular implementation of a method of safety audio error detection that may be performed by the device of FIG. 1, in accordance with some examples of the present disclosure.

FIG. 9 is a block diagram of a particular illustrative example of a device that is operable to perform safety audio error detection, in accordance with some examples of the present disclosure.

### V. DETAILED DESCRIPTION

Safety audio, such as a pedestrian detection warning, collision warning, over-speed warning, etc., is a safety-critical feature in some vehicles. A safety audio stream is typically interleaved with an infotainment audio stream and transmitted via an audio interface to a speaker pad for playout. The safety audio stream can be compromised for various reasons, e.g., hardware malfunction, pad level electrical issues, electromagnetic interference, etc.

Systems and methods of safety audio error detection are disclosed. In some examples, audio samples (e.g., corresponding to original safety audio interleaved with infotainment audio) are stored in an audio buffer. The stored audio samples are retrieved from the audio buffer and provided to a speaker pad for playout. The safety audio analysis engine obtains audio samples that are based on buffered audio samples. To illustrate, the safety audio analysis engine can obtain audio samples that are provided as feedback from the speaker pad. The obtained audio samples may differ from original audio samples (e.g., as stored in a memory prior to buffering) due to various reasons, e.g., hardware malfunction, pad level electrical issues, electromagnetic interference, etc.

The safety audio analysis engine extracts, based on a safety audio sample position configuration, safety audio samples from the obtained audio samples. In an example, a bitmask corresponds to the safety audio sample position configuration, and the safety audio analysis engine applies the bitmask to the obtained audio samples to extract the safety audio samples (e.g., samples of the obtained audio samples that are not masked by the bitmask). The safety audio analysis engine generates an error output based on the extracted safety audio samples. For example, the safety audio analysis engine determines a generated checksum of the extracted safety audio samples, obtains a target checksum of the original safety audio samples, and generates the error output based on a comparison of the generated checksum and the target checksum. The error output indicates whether an error is detected in the generated checksum. In some examples, the safety audio analysis engine provides the error output to an error detection engine and the error detection engine generates an alert in response to determining that the error output indicates an error. A technical advantage of the safety audio analysis engine includes an ability to use the safety audio sample position configuration to efficiently extract safety audio samples from obtained audio samples to determine whether there is an error in the safety audio. The quick identification of any safety audio errors can lead to improved vehicle safety.

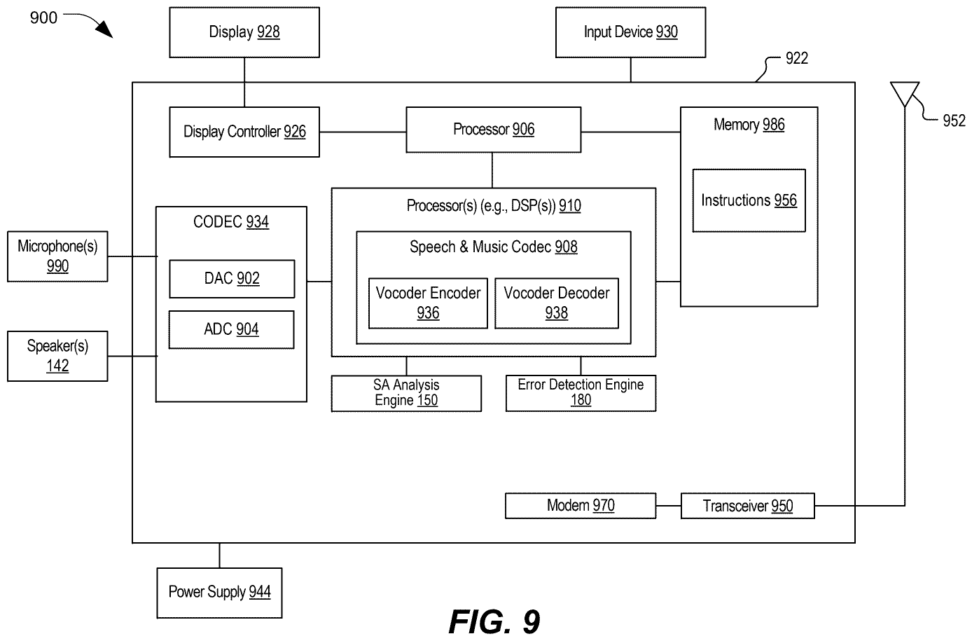

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 9 depicts a device 900 including one or more processors (“processor(s)” 910 of FIG. 9), which indicates that in some implementations the device 900 includes a single processor 910 and in other implementations the device 900 includes multiple processors 910. For ease of reference herein, such features are generally introduced as “one or more” features and are subsequently referred to in the singular or optional plural (as indicated by “(s)”) unless aspects related to multiple of the features are being described.

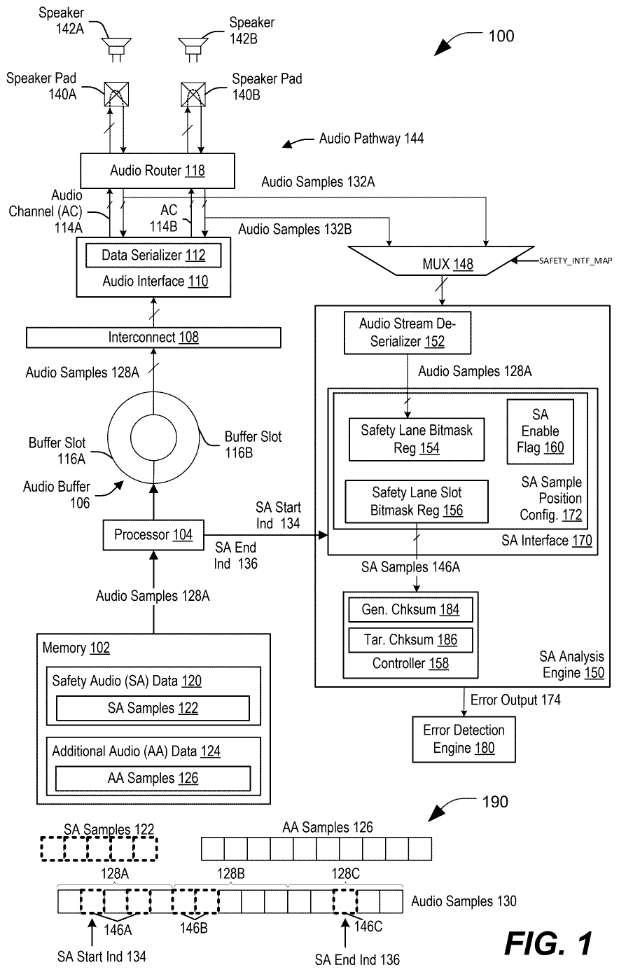

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple speakers are illustrated and associated with reference numbers 142A and 142B. When referring to a particular one of these speakers, such as a speaker 142A, the distinguishing letter “A” is used. However, when referring to any arbitrary one of these speakers or to these speakers as a group, the reference number 142 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

Referring to FIG. 1, a particular illustrative aspect of a device configured to perform safety audio error detection is disclosed and generally designated 100. The device 100 includes a processor 104 coupled to a memory 102, to an audio buffer 106, and to a safety audio (SA) analysis engine 150.

The audio buffer 106 is coupled via an interconnect 108 (e.g., a network-on-chip (NOC)) and an audio interface 110 to an audio router 118 (e.g., a top-level multiplexer module (TLMM)). The audio router 118 is coupled to one or more speaker pads 140, such as a speaker pad 140A and a speaker pad 140B. Each speaker pad 140 is associated with a respective speaker 142. For example, the speaker pad 140A is coupled to a speaker 142A, and the speaker pad 140B is coupled to a speaker 142B. It should be understood that two speaker pads 140 coupled to two speakers 142 is provided as an illustrative example; in other examples there can be fewer than two or more than two speaker pads 140 coupled to respective speakers 142.

The SA analysis engine 150 is coupled, via a multiplexer (MUX) 148, to an audio pathway 144 of the device 100. The audio pathway 144 starts from the memory 102, passes (in an outgoing direction) through the audio buffer 106, the interconnect 108, the audio interface 110, the audio router 118, and the speaker pads 140, and returns (in an incoming direction) from the speaker pads 140 via the audio router 118 to end at the audio interface 110. In the illustrated example, the SA analysis engine 150 is coupled via the MUX 148 to feedback from the audio router 118. In other examples, the SA analysis engine 150 can be coupled to one or more other locations along the audio pathway 144.

The SA analysis engine 150 includes an audio stream de-serializer 152 coupled via an SA interface 170 to a controller 158. Optionally, in some embodiments, the SA analysis engine 150 is also coupled to an error detection engine 180. In some other embodiments, the error detection engine 180 is omitted from the device 100.

The memory 102 is configured to store SA data 120 and additional audio (AA) data 124. The SA data 120 corresponds to safety audio, such as one or more safety alerts. In a particular aspect, the AA data 124 corresponds to non-safety audio, such as infotainment audio (e.g., music, news, audiobook, etc.). The processor 104 is configured to retrieve audio samples 128 from the memory 102 and to store the audio samples 128 in a buffer slot 116 of the audio buffer 106. The interconnect 108 is configured to retrieve the audio samples 128 from a buffer slot 116 of the audio buffer 106 and provide the audio samples 128 to the audio interface 110.

In some aspects, the processor 104 is configured to write to a buffer slot 116A of the audio buffer 106 concurrently with the interconnect 108 reading from a buffer slot 116B of the audio buffer 106. Optionally, in some embodiments, the audio buffer 106 corresponds to a ping-pong buffer that includes two buffer slots, such as the buffer slot 116A and the buffer slot 116B.

The audio interface 110 includes a data serializer 112 that is configured to output audio samples corresponding to audio channels 114 to the audio router 118. In a particular aspect, the data serializer 112 is configured to serialize data received via the interconnect 108 from the audio buffer 106 and the audio interface 110 is configured to provide the serialized data corresponding to the audio channels 114 to the audio router 118. The audio router 118 is configured to route the audio channels 114 to the speaker pads 140. For example, the audio router 118 is configured to provide serialized data corresponding to the audio channels 114 to the speaker pads 140. In a particular aspect, the audio router 118 is configured to route an audio channel 114A (e.g., left channel audio) to a speaker pad 140A of a speaker 142A (e.g., a left speaker), route an audio channel 114B (e.g., right channel audio) to a speaker pad 140B of a speaker 142B (e.g., a right speaker), or both. It should be understood that the audio router 118 routing the audio channels 114 to two speaker pads is provided as an illustrative example; in some other examples the audio router 118 can route the audio channels 114 to more than two speaker pads. It should be understood that the audio interface 110 corresponding to multi-channel audio is provided as an illustrative example; in other examples the audio interface 110 can correspond various types of audio interfaces, such as multiple inter-integrated circuit sound (MI2S), pulse code modulation (PCM), time-division multiplexing (TDM), or another type of audio interface. Audio samples 132 output from the speaker pads 140 are also provided as feedback via the audio router 118 to the audio interface 110.

The MUX 148 is configured to obtain audio samples that are based on audio samples buffered in the audio buffer 106. Optionally, in some embodiments, the MUX 148 obtains the audio samples 132 provided as feedback from the speaker pads 140 to the audio interface 110. In some implementations, the MUX 148 is configured to select the audio interface 110 from a plurality of audio interfaces and obtains the audio samples 132 directed to the audio interface 110. In some aspects, the MUX 148 is also configured to obtain frame configurations of the audio interface 110 and to provide the frame configurations to the audio stream de-serializer 152.

The audio stream de-serializer 152 is configured to deserialize the audio samples 132 received from the MUX 148 to reconstruct the audio samples 128. In some aspects, the audio stream de-serializer 152 is configured to deserialize the audio samples 132 based on the frame configurations received from the MUX 148. The audio stream de-serialize 152 is configured to provide the reconstructed audio samples 128 to the SA interface 170. The reconstructed audio samples 128 received at the SA interface 170 may differ from the audio samples 128 obtained from the memory 102 by the processor 104 because of various reasons, e.g., hardware malfunction, pad level electrical issues, electromagnetic interference, etc., along the audio pathway 144.

The SA interface 170 is configured to extract SA samples 146 from the audio samples 128 based on a SA sample position configuration 172 and to provide the extracted SA samples 146 to the controller 158. The controller 158 is configured to generate an error output 174 based on the SA samples 146. Optionally, in some embodiments, the processor 104 is configured to, concurrently with retrieving the audio samples 128 from the memory 102 to store in the audio buffer 106, generate a target (tar.) checksum (chksum) 186 of the SA samples 146 of the audio samples 128. Optionally, in some other embodiments, the processor 104 is configured to, concurrently with retrieving the audio samples 128 from the memory 102, retrieve the target checksum 186 of the SA samples 146 from the memory 102. The controller 158 is configured to obtain the target checksum 186 from the processor 104. For example, the processor 104 is configured to provide the target checksum 186 to the SA analysis engine 150. Optionally, in some embodiments, the target checksum 186 corresponds to a cyclic redundancy check (CRC) of the SA samples 146. The controller 158 is also configured to generate a generated (gen.) checksum (chksum) 184 of the extracted SA samples 146. Optionally, in some embodiments, the generated checksum 184 corresponds to a CRC of the extracted SA samples 146. The controller 158 is configured to generate an error output 174 based on a comparison of the generated checksum 184 and the target checksum 186. For example, the error output 174 may indicate whether an error is detected in the extracted SA samples 146 based on a difference between the generated checksum 184 and the target checksum 186.

Optionally, in some embodiments, the controller 158 is configured to provide the error output 174 to the error detection engine 180. The error detection engine 180 is configured to generate an alert in response to determining that the error output 174 indicates that an error is detected.

In an example 190, audio samples 130 include SA samples 122 of the SA data 120 interleaved with AA samples 126 of the AA data 124. During operation of the device 100, the processor 104 obtains sets of the audio samples 130 from the memory 102 and stores the sets of the audio samples 130 in the audio buffer 106. In an illustrative example, the audio samples 130 include audio samples 128A, audio samples 128B, and audio samples 128C. The audio samples 128A include SA samples 146A interleaved with a first subset of the AA samples 126. The audio samples 128B include SA samples 146B interleaved with a second subset of the AA samples 126. The audio samples 128C include SA samples 146C interleaved with a third subset of the AA samples 126.

The processor 104 writes a first set of the audio samples 130 (e.g., the audio samples 128A) to the buffer slot 116A of the audio buffer 106 during a first audio period. In a particular aspect, an “audio period” corresponds to a duration taken to write to a buffer slot 116 of the audio buffer 106. The processor 104, responsive to writing an initial audio sample of the SA data 120 (e.g., an initial audio sample of the SA samples 146A in the audio samples 128A) to the audio buffer 106, provides a SA start indicator (ind) 134 to the SA interface 170.

During a second audio period, the processor 104 writes a second set of the audio samples 130 (e.g., the audio samples 128B) to the buffer slot 116B of the audio buffer 106 concurrently with the interconnect 108 reading the audio samples 128A from the buffer slot 116A and transmitting the audio samples 128A via the audio interface 110 and the audio router 118 to one or more speaker pads 140 of one or more speakers 142.

During a third audio period, the processor 104 writes the audio samples 128C to the buffer slot 116A concurrently with the interconnect 108 reading the audio samples 128B from the buffer slot 116B. The processor 104 and the interconnect 108 thus operate concurrently to playout audio corresponding to the audio samples 130. The processor 104, responsive to writing a last audio sample of the SA data 120 (e.g., a last audio sample of the SA samples 146C in the audio samples 128C) to the audio buffer 106, provides an SA end indicator 136 to the SA interface 170.

As described above, the interconnect 108 provides audio samples obtained from a buffer slot 116 to the audio interface 110. In an example, the data serializer 112 of the audio interface 110 outputs audio samples corresponding to audio channels 114 to the audio router 118 and the audio router 118 routes the audio samples to the speaker pads 140. To illustrate, the data serializer 112 outputs a first subset of the audio samples 128A (e.g., audio samples 132A) of an audio channel 114A and a second subset of the audio samples 128A (e.g., audio samples 132B) of an audio channel 114B to the audio router 118. The audio router 118 provides the audio channel 114A to the speaker pad 140A of the speaker 142A and the audio channel 114B to the speaker pad 140B of the speaker 142B. Audio samples (e.g., the audio samples 132 corresponding to the audio channels 114) output from the speaker pads 140 are also provided as feedback via the audio router 118 to the audio interface 110. The audio pathway 144 of the audio samples 130 thus starts from the memory 102, passes through the audio buffer 106, the interconnect 108, the audio interface 110, the audio router 118, and the speaker pads 140, and returns from the speaker pads 140 via the audio router 118 to end at the audio interface 110.

The SA interface 170 obtains the reconstructed audio samples 128A from the audio pathway 144 that are based on the audio samples 128A that were buffered in the audio buffer 106. For example, the MUX 148 obtains the audio samples 132A, 132B that are provided as feedback from the speaker pads 140A, 140B, respectively, to the audio interface 110. In some implementations, the MUX 148 selects the audio interface 110 from a plurality of audio interfaces and obtains the audio samples 132 directed to the audio interface 110 (e.g., the selected audio interface). In some aspects, the MUX 148 obtains frame configurations of the audio interface 110 (e.g., the selected audio interface).

The audio stream de-serializer 152 deserializes the audio samples 132A and the audio samples 132B to reconstruct the audio samples 128A. In some aspects, the audio stream de-serializer 152 deserializes the audio samples 132A and the audio samples 132B based on the frame configurations of the audio interface 110. The audio stream de-serializer 152 provides the reconstructed audio samples 128A to the SA interface 170. The reconstructed audio samples 128A at the SA analysis engine 150 may differ from the audio samples 128A obtained from the memory 102 by the processor 104 because of various reasons, e.g., hardware malfunction, pad level electrical issues, electromagnetic interference, etc., along the audio pathway 144.

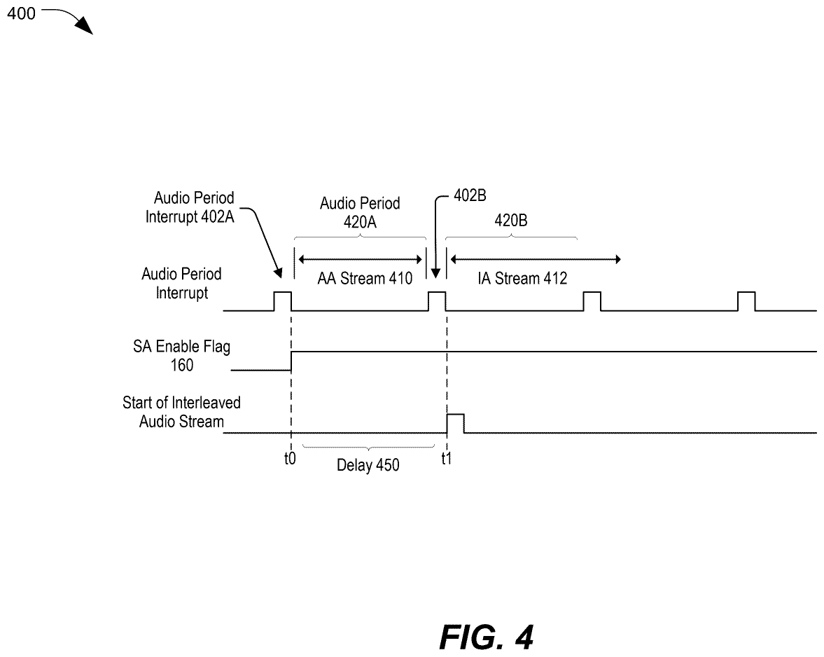

The SA interface 170 extracts, based on the SA sample position configuration 172, SA samples 146A from the reconstructed audio samples 128A. The SA sample position configuration 172 is based on an SA enable flag 160, one or more safety lane bitmask registers 154, one or more safety lane slot bitmask registers 156, or a combination thereof. In some examples, the SA sample position configuration 172 includes the SA enable flag 160 to indicate when to initiate extraction from the reconstructed audio samples 128A and the bitmasks to identify which samples to extract. To illustrate, the SA interface 170, responsive to receipt of the SA start ind 134, enables (e.g., sets to 1) the SA enable flag 160 to indicate that SA samples could be positioned in the audio samples received by the SA interface 170 and that extraction of the SA samples can be initiated. The SA interface 170, responsive to receipt of the SA end ind 136, disables (e.g., sets to 0) the SA enable flag 160 to indicate that audio samples received by the SA interface 170 do not include SA samples. In some aspects, the SA interface 170 can be bypassed or disabled when the SA enable flag 160 is disabled and no safety audio error detection is performed on (e.g., no error output 174 is generated for) any audio samples received at the SA analysis engine 150. In some aspects, there is a delay between updating of the SA enable flag 160 and corresponding operations of the SA interface 170, as described with reference to FIG. 4, to account for the time between adding the relevant SA sample (e.g., an initial or last SA sample) to the audio buffer 106 and receipt of the SA sample at the SA interface 170.

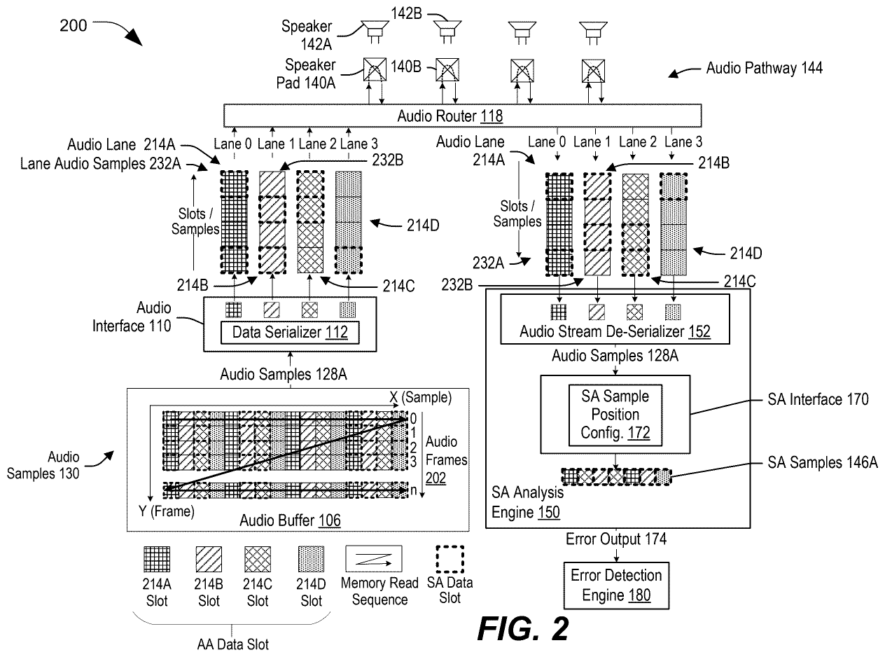

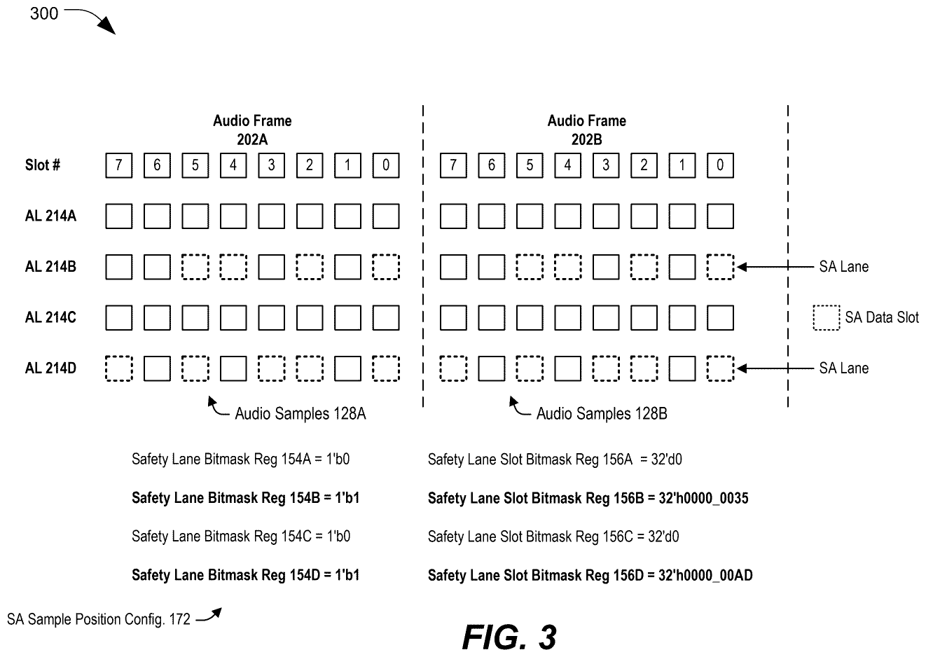

When the SA enable flag 160 is enabled, the SA interface 170 applies a bitmask to the reconstructed audio samples 128A to extract the SA samples 146A. In some examples, the reconstructed audio samples 128 are logically organized into audio lanes and slots, the SA sample position configuration 172 includes safety lane bitmask registers 154 and safety lane slot bitmask registers 156 corresponding to respective audio lanes. A safety lane bitmask register 154 of a particular audio lane includes a lane bitmask indicating whether the particular audio lane can include SA samples, and a safety lane slot bitmask register 156 of the particular audio lane includes a slot bitmask indicating positions of SA samples in the particular audio lane, as further described with reference to FIGS. 2-3. In a particular aspect, the SA interface 170 applies the lane bitmask to the reconstructed audio samples 128A to extract audio samples of the particular lane, and the SA interface 170 applies the slot bitmask to the lane audio samples to extract SA samples (e.g., a subset of the SA samples 146A) of the particular lane. The SA interface 170 may apply multiple lane and slot bitmasks to extract the SA samples 146A.

The controller 158 generates the error output 174 based on the extracted SA samples 146A. For example, the controller 158 determines the generated checksum 184 of the extracted SA samples 146A. The controller 158 also obtains the target checksum 186 of the SA samples 146A retrieved by the processor 104 from the memory 102 (e.g., of the SA samples included in the original non-reconstructed audio samples 128A). For example, the processor 104 obtains (e.g., generates or retrieves from the memory 102) the target checksum 186 of the SA samples 146A. Optionally, in some embodiments, the processor 104 provides the target checksum 186 to the SA analysis engine 150 concurrently with storing the audio samples 128A to the buffer slot 116A.

The controller 158 generates the error output 174 based on a comparison of the generated checksum 184 and the target checksum 186. For example, if the generated checksum 184 does not match the target checksum 186, the error output 174 indicates that an error is detected. Alternatively, if the generated checksum 184 matches the target checksum 186, the error output 174 indicates that no error is detected. In some embodiments, the controller 158, in response to determining that the generated checksum 184 is identical to the target checksum 186, determines the generated checksum 184 matches the target checksum 186. In some other embodiments, the controller 158, in response to determining that a difference between the generated checksum 184 and the target checksum 186 is within a tolerance threshold (e.g., fewer than 3 bit values are different), determines the generated checksum 184 matches the target checksum 186. The controller 158 provides the error output 174 to an error detection engine 180 to initiate one or more operations at the error detection engine 180. For example, the error detection engine 180 generates an alert in response to determining that the error output 174 indicates an error in the extracted SA samples 146A.

A technical advantage of the device 100 includes efficient SA sample extraction using bitmasks of the SA sample position configuration 172. The extracted SA samples can be used for quick identification of any safety audio errors that can improve vehicle safety.

FIG. 2 is a diagram of an illustrative aspect of operations 200 associated with safety audio error detection, in accordance with some examples of the present disclosure. In a particular aspect, one or more of the operations 200 are performed by the processor 104, the interconnect 108, the audio interface 110, the data serializer 112, the audio router 118, the MUX 148, the audio stream de-serializer 152, the SA interface 170, the controller 158, the SA analysis engine 150, the error detection engine 180, the device 100, or a combination thereof.

In the example shown in FIG. 2, the audio samples 130 are logically organized into a plurality of audio frames 202 (e.g., n audio frames, where n is a positive integer greater than 1). In a particular aspect, the audio samples 130 are stored in the memory 102 of FIG. 1 as data slots distributed across audio lanes. The audio samples 130 are read from the memory 102 and provided to the audio buffer 106 in order of audio frames and in order of data slots within an audio frame. Each audio frame 202 includes a respective subset of the audio samples 130. For example, a first audio frame 202 (e.g., an audio frame 0) includes a first subset of the audio samples 130 (e.g., audio samples corresponding to data slots 0-15), and a second audio frame 202 (e.g., an audio frame 1) includes a second subset of the audio samples 130 (e.g., audio samples corresponding to data slots 16-31). Audio samples (e.g., data slots) illustrated with a dashed outline in FIG. 2 correspond to the SA samples 122, and the remaining audio samples correspond to the AA samples 126.

Particular data slots of an audio frame 202 are designated for SA data. In the example of FIG. 2, the SA sample position configuration 172 indicates that data slots 0, 2, 5, 6, 12, 13, and 15 of the audio frame 202 are designated for SA data and remaining data slots of the audio frame 202 are designated for AA data. In a particular aspect, the processor 104 constructs the audio frame 202 based on the SA sample position configuration 172. For example, as the processor 104 retrieves samples from the memory 102 to populate the audio frame 202, the processor 104 obtains a next sample of the SA samples 122 from the memory 102 to populate a next data slot of the audio frame 202 that is designated for SA data, and the processor 104 obtains a next sample of the AA samples 126 from the memory 102 to populate a next data slot of the audio frame 202 that is designated for AA data.

The processor 104 writes the audio frame 202 to a buffer slot 116 of the audio buffer 106. The audio interface 110 retrieves audio samples 128A corresponding to the audio frame 202 from the audio buffer 106 and the data serializer 112 serializes the retrieved audio samples 128A into respective audio lanes 214 to provide to the audio router 118. In a particular aspect, the audio samples 130 of the audio frames 202 are logically organized into the audio lanes 214 that each includes a plurality of data slots. To illustrate, particular data slots of an audio frame 202 are allocated to particular audio lanes 214.

In embodiments in which a count of audio lanes 214 (e.g., 4) is less than a count of data slots (e.g., 16) of an audio frame 202, multiple data slots of an audio frame 202 are allocated to the same audio lane 214. For example, data slots 0, 4, 8, and 12 of the audio frames 202 are allocated to an audio lane 214A. As another example, data slots 1, 5, 9, and 13 of the audio frames 202 are allocated to an audio lane 214B. As yet another example, data slots 2, 6, 10, and 14 of the audio frames 202 are allocated to an audio lane 214C. As another example, data slots 3, 7, 11, and 15 of the audio frames 202 are allocated to an audio lane 214D. In FIG. 2, data slots corresponding to the audio lane 214A are illustrated with a grid fill pattern, data slots corresponding to the audio lane 214B are illustrated with a diagonal fill pattern, data slots corresponding to the audio lane 214C are illustrated with a cross-hatch fill pattern, and data slots corresponding to the audio lane 214D are illustrated with a dotted fill pattern.

The data serializer 112 provides, to the audio router 118, sets of lane audio samples 232 of the retrieved audio samples 128A that correspond to the audio lanes 214. For example, the data serializer 112 provides in series/in a sequence, to the audio router 118, a first set of lane audio samples 232A of the retrieved audio samples 128A that correspond to the audio lane 214A. To illustrate, the first set of lane audio samples 232A includes the audio samples corresponding to data slots 0, 4, 8, and 12 of an audio frame 202 (e.g., an audio frame 0). As another example, the data serializer 112 provides in series/in a sequence, to the audio router 118, a second set of lane audio samples 232B of the retrieved audio samples 128A that correspond to the audio lane 214B. To illustrate, the second set of lane audio samples 232B includes the audio samples corresponding to data slots 1, 5, 9, and 13 of the audio frame 202. Similarly, the data serializer 112 provides, to the audio router 118, a third set of lane audio samples that correspond to the audio lane 214C and a fourth set of lane audio samples that correspond to the audio lane 214D.

The audio router 118 outputs the lane audio samples 232 to the speaker pads 140 and receives the lane audio samples 232 from the speaker pads 140 as feedback. For example, the audio router 118 outputs the lane audio samples 232A to a first subset of the speaker pads 140 and receives the lane audio samples 232A as feedback from the first subset of speaker pads 140. In a particular aspect, the first subset of speaker pads 140 includes the speaker pad 140A, one or more additional speaker pads 140, or a combination thereof. As another example, the audio router 118 concurrently with outputting the lane audio samples 232A to the first subset of speaker pads 140, outputs the lane audio samples 232B to a second subset of the speaker pads 140 and receives the lane audio samples 232B as feedback from the second subset of speaker pads 140. In a particular aspect, the second subset of speaker pads 140 includes the speaker pad 140B, one or more additional speaker pads 140, or a combination thereof.

The audio stream de-serializer 152 obtains audio samples that are based on audio samples buffered in the audio buffer 106. For example, the audio stream de-serializer 152 obtains the lane audio samples 232 from the audio pathway 144 (e.g., as the feedback from the speaker pads 140) and deserializes the lane audio samples 232 to generate the reconstructed audio samples 128A. To illustrate, the audio stream de-serializer 152 deserializes the first set of lane audio samples 232A, the second set of lane audio samples 232B, the third set of lane audio samples, and the fourth set of lane audio samples to reconstruct the audio samples 128A. The reconstructed audio samples 128A at the SA analysis engine 150 may differ from the audio samples 128A stored in the memory 102 due to various reasons, as described with reference to FIG. 1.

The SA interface 170, based on the SA sample position configuration 172, extracts the SA samples 146A from the reconstructed audio samples 128A, as described with reference to FIG. 1. For example, the SA interface 170, based on determining that the SA sample position configuration 172 indicates that data slots 0, 2, 5, 6, 12, 13, and 15 of an audio frame 202 are designated for SA data, extracts the SA samples 146A from the data slots 0, 2, 5, 6, 12, 13, and 15 of an audio frame 202 (e.g., the audio frame 0) corresponding to the audio samples 128A. The SA analysis engine 150 generates the error output 174 based on the SA samples 146A and provides the error output 174 to the error detection engine 180, as described with reference to FIG. 1.

FIG. 3 is a diagram of an illustrative example 300 of audio frames and registers storing bitmasks that can be used to extract safety audio from the audio frames, in accordance with some examples of the present disclosure.

In the example 300 shown in FIG. 3, the audio samples 128 are logically organized into 4 audio lanes, e.g., audio lanes 214A, 214B, 214C, and 214D. The audio samples 128 organized into four audio lanes is provided as an illustrative example; in other examples, the audio samples 128 can be organized into fewer than four or more than four audio lanes. Each audio lane 214 includes 8 data slots (slots 0-7) of an audio frame 202. For example, an audio frame 202A includes audio samples 128A organized into the audio lanes 214A, 214B, 214C, and 214D, and each audio lane 214 includes 8 data slots (e.g., slots 0-7). As another example, an audio frame 202B includes audio samples 128B organized into the audio lanes 214A, 214B, 214C, and 214D, and each audio lane 214 includes 8 data slots (e.g., slots 0-7).

It should be understood that an audio frame 202 including 16 data slots in the example 200 of FIG. 2, and an audio frame 202 including 32 data slots in the example 300 are provided as illustrative examples; in other examples an audio frame 202 can be logically organized to include any number of slots. In some examples, an audio frame 202 can include fewer than 4 audio lanes or more than 4 audio lanes. In some examples, an audio lane can include any count of data slots.

The device 100 of FIG. 1 includes a safety lane bitmask register 154 and a safety lane slot bitmask register 156 associated with each audio lane 214. For example, the device 100 includes a safety lane bitmask register 154A and a safety lane slot bitmask register 156A associated with the audio lane 214A, a safety lane bitmask register 154B and a safety lane slot bitmask register 156B associated with the audio lane 214B, a safety lane bitmask register 154C and a safety lane slot bitmask register 156C associated with the audio lane 214C, and a safety lane bitmask register 154D and a safety lane slot bitmask register 156D associated with the audio lane 214D.

The SA sample position configuration 172 for an audio lane 214 is based on a lane bitmask stored in the corresponding safety lane bitmask register 154 and a slot bitmask stored in the corresponding safety lane slot bitmask register 156. For example, a safety lane bitmask register 154 is configured to store a lane bitmask (e.g., a one-bit value) indicating whether a corresponding audio lane 214 corresponds to a SA lane. For example, a first value (e.g., 0) of a lane bitmask stored in the safety lane bitmask register 154 indicates that the corresponding audio lane 214 does not correspond to a SA lane. As another example, a second value (e.g., 1) of the lane bitmask stored in the safety lane bitmask register 154 indicates that the corresponding audio lane 214 corresponds to a SA lane. A SA lane can include at least one SA sample. In some aspects, a one-bit value having a value of 0 can be indicated as 1′b0, a one-bit value having a value of 1 can be indicated as 1′b1, a 32-bit decimal value of having a value of 0 can be indicated as 32′d0, a 32-bit hexadecimal value of 35 can be indicated as 32′h0000_0035, and a 32-bit hexadecimal value of AD can be indicated as 32′h0000_00AD.

The safety lane bitmask register 154B has a lane bitmask indicating the second value (e.g., 1) to indicate that the audio lane 214B can include SA samples. Similarly, the safety lane bitmask register 154D has a lane bitmask indicating the second value (e.g., 1) to indicate that the audio lane 214D can include SA samples. Each of the remaining safety lane bitmask registers (e.g., the safety lane bitmask register 154A and the safety lane bitmask register 154C) store a lane bitmask indicating the first value (e.g., 0) to indicate that the corresponding audio lane (e.g., the audio lane 214A and the audio lane 214C) does not include SA samples.

A safety lane slot bitmask register 156 is configured to store a slot bitmask indicating which data slots, if any, of a corresponding audio lane 214 can include SA samples. The safety lane slot bitmask register 156B corresponding to the audio lane 214B that can include SA samples stores a value (e.g., 35 in hexadecimal) that corresponds to a slot bitmask (e.g., 00110101 in binary) that indicates slot positions (e.g., slots 0, 2, 4, and 5) of SA samples in the audio lane 214B. Similarly, the safety lane slot bitmask register 156D corresponding to the audio lane 214D that can include SA samples stores a value (e.g., AD in hexadecimal) that corresponds to a slot bitmask (e.g., 10101101 in binary) that indicates slot positions (e.g., slots 0, 2, 3, 5, and 7) of SA samples in the audio lane 214D. Each of the remaining safety lane slot bitmask registers (e.g., the safety lane slot bitmask register 156A and the safety lane slot bitmask register 156C) stores a slot bitmask indicating a first value (e.g., 0) to indicate that none of the data slots of a corresponding audio lane 214 include SA samples.

Optionally, in some embodiments, the SA interface 170 of FIG. 1, in response to determining that the safety lane bitmask register 154A has a lane bitmask that has a first value (e.g., 0) indicating that the audio lane 214A does not include SA samples, disregards the lane audio samples 232A of the audio lane 214A in extracting the SA samples 146A. The SA interface 170, in response to determining that the safety lane bitmask register 154B has a lane bitmask that has a second value (e.g., 1) indicating that the audio lane 214B can include SA samples, obtains a slot bitmask from the safety lane slot bitmask register 156B and applies the slot bitmask to the lane audio samples 232B of the audio lane 214B to extract a first subset of the SA samples 146A from the corresponding slots of the audio lane 214B. Similarly, the SA interface 170 disregards the lane audio samples of the audio lane 214C and applies the slot bitmask from the safety lane slot bitmask register 156D to the lane audio samples of the audio lane 214D to extract a second subset of the SA samples 146A from the corresponding slots of the audio lane 214D. The SA interface 170 reconstructs the SA samples 146A including the extracted subsets.

Optionally, in some other embodiments, the audio stream de-serializer 152 combines the lane audio samples 232A, 232B, 232C, and 232D to generate the reconstructed audio samples 128A. The SA interface 170 of FIG. 1 receives the reconstructed audio samples 128A from the audio stream de-serializer 152 and separates (e.g., extracts) the lane audio samples 232A, 232B, 232C, and 232D from the reconstructed audio samples 128. In some examples, the SA interface 170, in response to determining that the safety lane bitmask register 154A has a lane bitmask that has a first value (e.g., 0) indicating that the audio lane 214A does not include SA samples, refrains from extracting the lane audio samples 232A of the audio lane 214A from the reconstructed audio samples 128A. The SA interface 170, in response to determining that the safety lane bitmask register 154B has a second value (e.g., 1) indicating that the audio lane 214B can include SA samples, applies a lane bitmask to the reconstructed audio samples 128A to extract the lane audio samples 232B of the audio lane 214B (e.g., corresponding to samples 1, 5, 9, 13, 17, 21, 25, and 29 of the reconstructed audio samples 128A). The SA interface 170 obtains a slot bitmask from the safety lane slot bitmask register 156B and applies the slot bitmask to the lane audio samples 232B to extract a first subset of the SA samples 146A from the corresponding slots of the audio lane 214B. Similarly, the SA interface 170 refrains from extracting the lane audio samples of the audio lane 214C, extracts the lane audio samples of the audio lane 214D, and applies the slot bitmask from the safety lane slot bitmask register 156D to the lane audio samples of the audio lane 214D to extract a second subset of the SA samples 146A. The SA interface 170 reconstructs the SA samples 146A including the extracted subsets.

FIG. 4 is a timing diagram 400 of an illustrative aspect of operations associated with safety audio error detection, in accordance with some examples of the present disclosure. The timing diagram 400 depicts an example of a delay 450 between enabling of the SA enable flag 160 and receipt of an interleaved audio (IA) stream 412 at the SA interface 170.

The SA enable flag 160 is enabled (e.g., responsive to receipt of the SA start ind 134 from the processor 104) at a time t0. In a particular aspect, the SA enable flag 160 is enabled concurrently with or after an audio period interrupt 402A. In some embodiments, the SA enable flag 160 is enabled responsive to receipt of the audio period interrupt 402A. For example, the processor 104, responsive to receipt of the audio period interrupt 402A, writes an initial audio sample of the SA data 120 (e.g., of the IA stream 412) to the audio buffer 106. The processor 104, responsive to writing the initial audio sample of the SA data 120 to the audio buffer 106, provides the SA start ind 134 to the SA interface 170. The SA interface 170 enables the SA enable flag 160 responsive to receipt of the SA start ind 134.

The SA interface 170 starts receiving the interleaved audio stream 412 after a next audio period interrupt 402B at a time t1. For example, during an audio period 420A between the audio period interrupt 402A and the audio period interrupt 402B, the interconnect 108 retrieves AA samples of an AA stream 410 from a buffer slot 116A concurrently with the processor 104 writing audio samples 128A of the interleaved audio stream 412 to a buffer slot 116B. The interconnect 108 provides the AA samples to the speaker pads 140. The SA interface 170 refrains from processing audio samples obtained from the audio pathway 144 during the audio period 420A.

During an audio period 420B after the audio period interrupt 402B, the interconnect 108 retrieves the audio samples 128A from the buffer slot 116B and provides the audio samples 128A to the speaker pads 140. The SA interface 170 processes audio samples from the audio pathway 144 to extract the SA samples 146A during the audio period 420B.

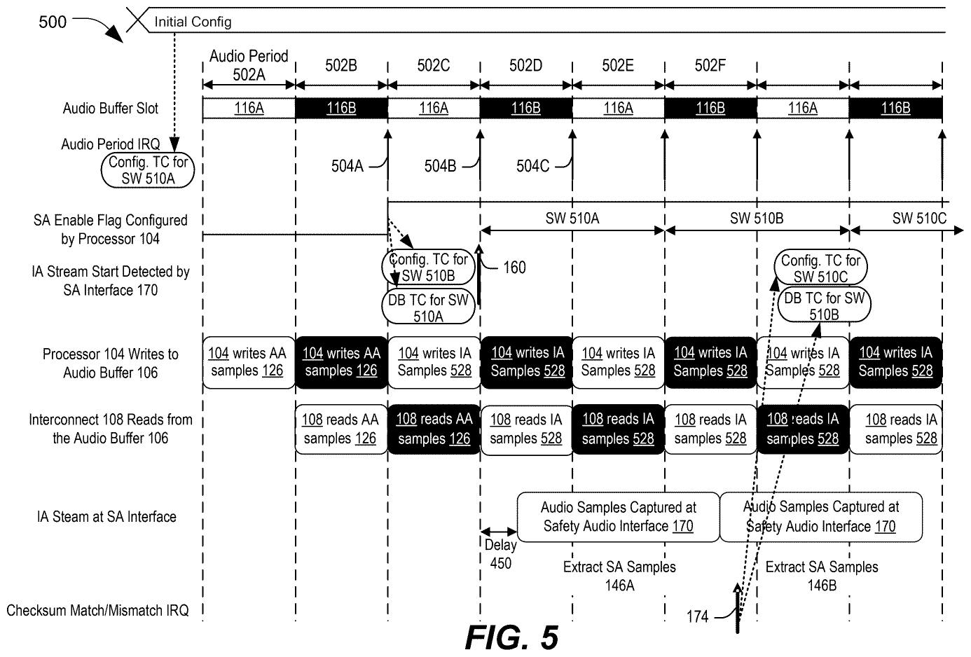

FIG. 5 is a diagram 500 of an illustrative aspect of operations associated with safety audio error detection, in accordance with some examples of the present disclosure. In a particular aspect, the processor 104, the SA analysis engine 150, or both, perform an initial configuration set up. During the configuration set up, in some examples, a sample width of an audio sample is selected based on a user input, a configuration setting, default data, or a combination thereof. In some aspects, the processor 104 designates buffer slots 116 of the audio buffer 106. For example, the processor 104 designates a first portion of the audio buffer 106 as a buffer slot 116A (e.g., ping slot) and a second portion of the audio buffer 106 as a buffer slot 116B (e.g., pong slot). In a particular aspect, the processor 104 configures (e.g., determines) a target checksum (TC) 186 for SA samples 146A of audio samples 128A of FIG. 1. The audio samples 128A correspond to a set of interleaved audio samples 528 to be read by the interconnect 108 during a Safe Audio window (SW) 510A, as described herein. In some aspects, a “safe audio window” refers to a duration to read interleaved audio data corresponding to both buffer slots 116 of the audio buffer 106. Since an audio period 502 refers to a duration to read one buffer slot 116, a safe audio window 510 to read two buffer slots 116 has the same duration as two audio periods 502.

During an audio period 502A, the processor 104 retrieves a first set of AA samples 126 of the AA stream 410 from the memory 102 and writes the first set of AA samples 126 to the buffer slot 116A. During an audio period 502B, the processor 104 retrieves a second set of AA samples 126 of the AA stream 410 from the memory 102 and writes the second set of AA samples 126 to the buffer slot 116B. Concurrently with the processor 104 writing the second set of AA samples 126 to the buffer slot 116B, the interconnect 108 reads the first set of AA samples 126 from the buffer slot 116A. When the interconnect 108 completes reading the first set of AA samples 126 from the buffer slot 116A, the interconnect 108 sends an interrupt request (IRQ) 504A to the processor 104 to indicate that the buffer slot 116A is available.

During an audio period 502C and responsive to the IRQ 504A, the processor 104 retrieves a first set of IA samples 528 of the IA stream 412 from the memory 102, and writes the first set of IA samples 528 to the buffer slot 116A. Responsive to writing the first set of IA samples 528 to the buffer slot 116A, the processor 104 sends the SA start indicator 134 to the SA analysis engine 150. The SA interface 170, responsive to receiving the SA start indicator 134, determines that the SA enable flag 160 is to be enabled at the end of the audio period 502C. The processor 104, concurrently with sending the SA start indicator 134 to the SA analysis engine 150, double buffers (DB) the target checksum 186 for the SA samples 146A. For example, the processor 104 provides the target checksum 186 for the SA samples 146A to the SA analysis engine 150. The controller 158 stores the target checksum 186, e.g., in a register or other memory. The processor 104 configures (e.g., determines) a target checksum 186 for SA samples 146B of audio samples 128B of FIG. 1. The audio samples 128B correspond to a next set of interleaved audio samples 528 to be read by the interconnect 108 during a SW 510B, as described herein.

Concurrently with the processor 104 writing the first set of IA samples 528 to the buffer slot 116A, the interconnect 108 reads the second set of AA samples 126 from the buffer slot 116B. When the interconnect 108 completes reading the second set of AA samples 126 from the buffer slot 116B, the interconnect 108 sends an IRQ 504B to the processor 104 to indicate that the buffer slot 116B is available and to indicate a start of an audio period 502D. At the start of the audio period 502D, the SA interface 170 enables the SA enable flag 160 (responsive to receiving the SA start indicator 134 during the audio period 502C) and the SW 510A is initiated.

During the audio period 502D and responsive to the IRQ 504B, the processor 104 retrieves a second set of IA samples 528 of the IA stream 412 from the memory 102, and writes the second set of IA samples 528 to the buffer slot 116B. Concurrently with the processor 104 writing the second set of IA samples 528 to the buffer slot 116B, the interconnect 108 reads the first set of IA samples 528 from the buffer slot 116A. When the interconnect 108 completes reading the first set of IA samples 528 from the buffer slot 116A, the interconnect 108 sends an IRQ 504C to the processor 104 to indicate that the buffer slot 116A is available. Responsive to the SA enable flag 160 being enabled, the SA interface 170 is activated to start extracting SA samples 146A from the reconstructed audio samples 128A (e.g., the IA samples 528) received at the SA interface 170, as described with reference to FIG. 1. For example, the SA interface 170 extracts a first portion of the SA samples 146A during at least a portion of the audio period 502D.

The SW 510A ends at the end of an audio period 502E. For example, the interconnect 108 reads IA data from the buffer slot 116A during the audio period 502D and reads IA data from the buffer slot 116B during the audio period 502E. There is the delay 450 between a first time that the SA enable flag 160 is enabled and the interconnect 108 starts to read the IA data from the buffer slot 116A and a second time that the SA interface 170 starts receiving the corresponding IA data. In some aspects, the delay 450 is based on a configuration setting, default data, a user input, or a combination thereof. In some aspects, the SA interface 170, after the delay 450 subsequent to enabling the SA enable flag 160, initiates extraction of the first portion of the SA samples 146A.

The SA interface 170 continues to extract portions of the SA samples 146 for a duration of a SW 510 (e.g., two audio periods). For example, the SA interface 170 continues to extract a second portion of the SA samples 146A during the audio period 502E and a third portion of the SA samples 146A during at least a portion of an audio period 502F. The controller 158 determines a generated checksum 184 of extracted SA samples 146.

The controller 158 determines the generated checksum 184 during the audio period 502F based on the extracted SA samples 146A. The controller 158, in response to determining that the generated checksum 184 does not match the target checksum 186, generates an error output 174 (e.g., an error IRQ) indicating that an error is detected, as described with reference to FIG. 1.

The processor 104, responsive to the receiving the error output 174, double buffers the target checksum 186 for the SA samples 146B. For example, the processor 104 provides the target checksum 186 for the SA samples 146B to the SA analysis engine 150. The controller 158 stores the target checksum 186, e.g., in a register or other memory. The processor 104 configures (e.g., determines) a target checksum 186 for SA samples 146C of audio samples 128C of FIG. 1. The audio samples 128B correspond to next set of interleaved audio samples 528 to be read by the interconnect 108 during a SW 510C.

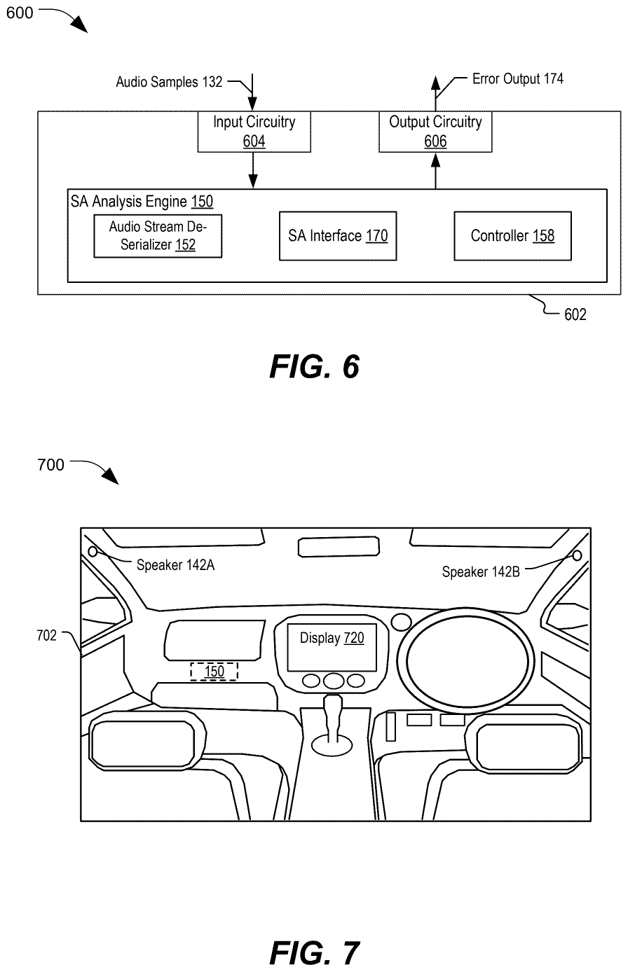

FIG. 6 depicts an implementation 600 of the device 100 as an integrated circuit 602 that includes the SA analysis engine 150. The integrated circuit 602 also includes input circuitry 604, such as one or more bus interfaces, to enable the audio samples 132 to be received for processing. The integrated circuit 602 also includes output circuitry 606, such as a bus interface, to enable sending of the error output 174. In some aspects, the output circuitry 606 sends the error output 174 to the error detection engine 180, a display device, a speaker, a network device, a communication device, or a combination thereof. The integrated circuit 602 enables implementation of safety audio error detection as a component in a system that includes speakers, such as a vehicle as depicted in FIG. 7.

FIG. 7 depicts an implementation 700 in which the device 100 corresponds to, or is integrated within, a vehicle 702, illustrated as a car. The vehicle 702 includes the SA analysis engine 150. The vehicle 702 also includes one or more additional components of the device 100 (not shown for convenience in FIG. 7), such as the memory 102, the processor 104, the audio buffer 106, the interconnect 108, the audio interface 110, the MUX 148, the error detection engine 180, the speaker pads 140, or a combination thereof. The vehicle 702 also includes the speaker 142A, the speaker 142B, one or more additional speakers, or a combination thereof. Safety audio error detection can be performed based on audio signals provided to the speakers 142, audio signals received as feedback from speaker pads 140, or both. In some implementations, the error output 174, an output of the error detection engine 180, or both, can be displayed via a display device 720.

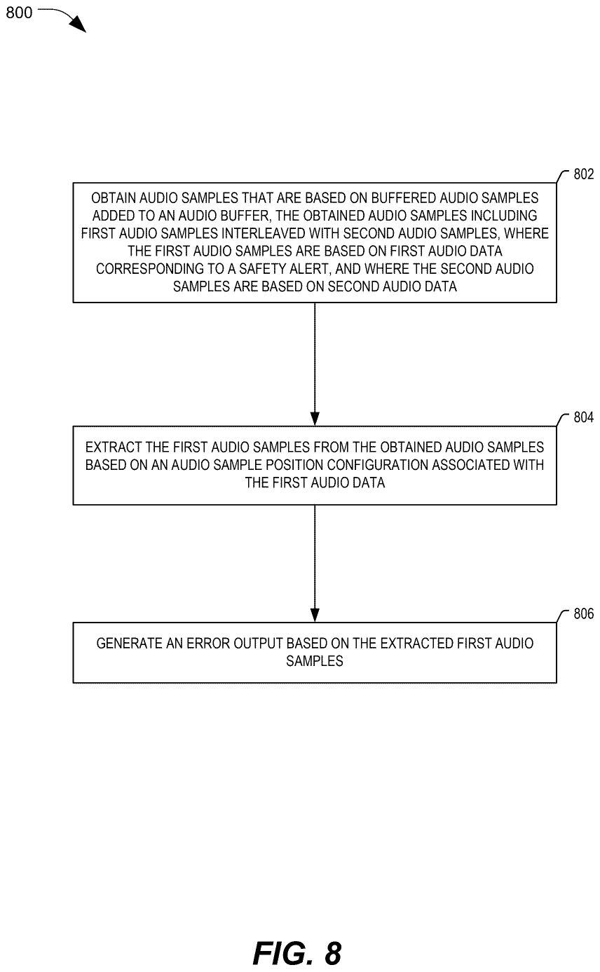

Referring to FIG. 8, a particular implementation of a method 800 of safety audio error detection is shown. In a particular aspect, one or more operations of the method 800 are performed by at least one of the audio stream de-serializer 152, the SA interface 170, the controller 158, the SA analysis engine 150, the device 100 of FIG. 1, or a combination thereof.

The method 800 includes, at 802, obtaining audio samples that are based on buffered audio samples added to an audio buffer. For example, the SA interface 170 of FIG. 1 obtains the reconstructed audio samples 128A that are based on the audio samples 128A added to the audio buffer 106, as described with reference to FIG. 1. The reconstructed audio samples 128A include SA samples 122 interleaved with AA samples 126. The SA samples 122 are based on SA data 120 corresponding to a safety alert. The AA samples 126 are based on AA data 124.

The method 800 also includes, at 804, extracting the first audio samples from the obtained audio samples based on an audio sample position configuration associated with the first audio data. For example, the SA interface 170 extracts the SA samples 146A from the reconstructed audio samples 128A based on the SA sample position configuration 172 associated with the SA data 120, as described with reference to FIGS. 1-3.

The method 800 further includes, at 806, generating an error output based on the extracted first audio samples. For example, the SA analysis engine 150 generates an error output 174 based on the SA samples 146A, as described with reference to FIG. 1.

The method 800 thus enables using the SA sample position configuration 172 to efficiently extract SA samples 146 from the audio samples 128 received at the SA analysis engine 150. The SA analysis engine 150 can perform error detection on the extracted SA samples 146. Faster safety audio extraction and safety audio error detection can improve vehicle safety.

The method 800 of FIG. 8 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 800 of FIG. 8 may be performed by a processor that executes instructions, such as described with reference to FIG. 9.

Referring to FIG. 9, a block diagram of a particular illustrative implementation of a device is depicted and generally designated 900. In various implementations, the device 900 may have more or fewer components than illustrated in FIG. 9. In an illustrative implementation, the device 900 may correspond to the device 100 of FIG. 1. In an illustrative implementation, the device 900 may perform one or more operations described with reference to FIGS. 1-8.

In a particular implementation, the device 900 includes a processor 906 (e.g., a CPU). The device 900 may include one or more additional processors 910 (e.g., one or more DSPs). In a particular aspect, the processor 104 of FIG. 1 corresponds to the processor 906, the processors 910, or a combination thereof. The processors 910 may include a speech and music coder-decoder (CODEC) 908 that includes a voice coder (“vocoder”) encoder 936, a vocoder decoder 938, or both. In a particular aspect, the processors 910 are coupled to, or include, the SA analysis engine 150, the error detection engine 180, or both. In a particular aspect, the SA analysis engine 150, the error detection engine 180, or both, may be implemented by a FPGA device, an ASIC, a processing unit, a controller, another hardware device, firmware device, or any combination thereof.

The device 900 may include a memory 986 and a CODEC 934. The memory 986 may include instructions 956, that are executable by the one or more additional processors 910 (or the processor 906) to implement the functionality described with reference to the SA analysis engine 150, the error detection engine 180, the processor 104, or a combination thereof. The device 900 may include a modem 970 coupled, via a transceiver 950, to an antenna 952.

The device 900 may include a display device 928 coupled to a display controller 926. One or more speakers 142, one or more microphones 990, or a combination thereof, may be coupled to the CODEC 934. The CODEC 934 may include a digital-to-analog converter (DAC) 902, an analog-to-digital converter (ADC) 904, or both. In a particular implementation, the CODEC 934 may receive analog signals from the microphone(s) 990, convert the analog signals to digital signals using the analog-to-digital converter 904, and provide the digital signals to the speech and music codec 908. The speech and music codec 908 may process the digital signals. In a particular implementation, the speech and music codec 908 may provide digital signals to the CODEC 934. The CODEC 934 may convert the digital signals to analog signals using the digital-to-analog converter 902 and may provide the analog signals to the one or more speakers 992.

In a particular implementation, the device 900 may be included in a system-in-package or system-on-chip device 922. In a particular implementation, the memory 986, the processor 906, the processors 910, the display controller 926, the CODEC 934, and the modem 970 are included in the system-in-package or system-on-chip device 922. In a particular implementation, an input device 930 and a power supply 944 are coupled to the system-in-package or the system-on-chip device 922. Moreover, in a particular implementation, as illustrated in FIG. 9, the display device 928, the input device 930, the one or more speakers 142, the one or more microphones 990, the antenna 952, and the power supply 944 are external to the system-in-package or the system-on-chip device 922. In a particular implementation, each of the display device 928, the input device 930, the one or more speakers 992, the one or more microphones 990, the antenna 952, and the power supply 944 may be coupled to a component of the system-in-package or the system-on-chip device 922, such as an interface or a controller.

The device 900 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, a vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining audio samples that are based on buffered audio samples added to an audio buffer. For example, the means for obtaining can correspond to the MUX 148, the audio stream de-serializer 152, the SA interface 170, the SA analysis engine 150, the device 100, the integrated circuit 602, the vehicle 702, the processor 906, the processor 910, the device 900, one or more other circuits or components configured to obtain audio samples, or any combination thereof. The obtained audio samples include first audio samples interleaved with second audio samples. The first audio samples are based on first audio data corresponding to a safety alert. The second audio samples are based on second audio data.

The apparatus also includes means for extracting the first audio samples from the obtained audio samples based on an audio sample position configuration associated with the first audio data. For example, the means for extracting can correspond to the SA interface 170, the SA analysis engine 150, the device 100, the integrated circuit 602, the vehicle 702, the processor 906, the processor 910, the device 900, one or more other circuits or components configured to extract the first audio samples from the obtained audio samples, or any combination thereof.

The apparatus further includes means for generating an error output based on the extracted first audio samples. For example, the means for generating can correspond to the controller 158, the SA analysis engine 150, the device 100, the integrated circuit 602, the vehicle 702, the processor 906, the processor 910, the device 900, one or more other circuits or components configured to generate the error output, or any combination thereof.

In some implementations, a non-transitory computer-readable medium (e.g., a computer-readable storage device, such as the memory 986) includes instructions (e.g., the instructions 956) that, when executed by one or more processors (e.g., the SA analysis engine 150, the one or more processors 910, or the processor 906), cause the one or more processors to obtain audio samples (e.g., the reconstructed audio samples 128A) that are based on buffered audio samples (e.g., the audio samples 128A) added to an audio buffer (e.g., the audio buffer 106). The obtained audio samples include first audio samples (e.g., the SA samples 122) interleaved with second audio samples (e.g., the AA samples 126). The first audio samples are based on first audio data (e.g., the SA data 120) corresponding to a safety alert. The second audio samples are based on second audio data (e.g., the AA data 124). The instructions also cause the one or more processors to extract the first audio samples from the obtained audio samples based on an audio sample position configuration (e.g., the SA sample position configuration 172) associated with the first audio data. The instructions further cause the one or more processors to generate an error output (e.g., the error output 174) based on the extracted first audio samples.

Particular aspects of the disclosure are described below in sets of interrelated Examples:

According to Example 1, a device includes a memory configured to store first audio data and second audio data, wherein the first audio data corresponds to a safety alert; and one or more processors coupled to the memory, wherein the one or more processors are configured to obtain audio samples that are based on buffered audio samples added to an audio buffer, the obtained audio samples including first audio samples interleaved with second audio samples, wherein the first audio samples are based on the first audio data, and wherein the second audio samples are based on the second audio data; extract the first audio samples from the obtained audio samples based on an audio sample position configuration associated with the first audio data; and generate an error output based on the extracted first audio samples.

Example 2 includes the device of Example 1, wherein the safety alert is associated with one or more components of a vehicle.

Example 3 includes the device of Example 2, wherein the one or more processors are integrated in the vehicle.

Example 4 includes the device of any of Examples 1 to 3, wherein the error output indicates whether an error associated with the extracted first audio samples is detected.

Example 5 includes the device of any of Examples 1 to 4, wherein the obtained audio samples correspond to feedback from a speaker pad after playout.

Example 6 includes the device of any of Examples 1 to 5, wherein the one or more processors are configured to receive, at a first time, an audio start indication that an initial audio sample of the first audio data has been added to the audio buffer, and wherein the audio sample position configuration is based at least in part on receipt of the audio start indication.

Example 7 includes the device of any of Examples 1 to 6, wherein the one or more processors are configured to apply a bitmask to the obtained audio samples to extract the first audio samples, and wherein the audio sample position configuration is based on the bitmask.

Example 8 includes the device of Example 7, wherein the one or more processors are configured to obtain the bitmask from a register.

Example 9 includes the device of any of Examples 1 to 8, wherein the one or more processors are configured to receive at a second time, an audio end indication that a last audio sample of the first audio data has been added to the audio buffer, and wherein the audio sample position configuration is based at least in part on receipt of the audio end indication.

Example 10 includes the device of any of Examples 1 to 9, wherein the one or more processors are configured to determine a generated checksum based on the extracted first audio samples; and generate the error output based on a comparison of the generated checksum and a target checksum of a corresponding first set of audio samples of the first audio data.

Example 11 includes the device of any of Examples 1 to 10, wherein the device further includes a modem configured to transmit the error output.

Example 12 includes the device of any of Examples 1 to 11, wherein the device further includes a display device configured to display the error output.

According to Example 13, a method includes obtaining, at a device, audio samples that are based on buffered audio samples added to an audio buffer, the obtained audio samples including first audio samples interleaved with second audio samples, wherein the first audio samples are based on first audio data corresponding to a safety alert, and wherein the second audio samples are based on second audio data; extracting, at the device, the first audio samples from the obtained audio samples based on an audio sample position configuration associated with the first audio data; and generating, at the device, an error output based on the extracted first audio samples.

Example 14 includes the method of Example 13, wherein the safety alert is associated with one or more components of a vehicle.

Example 15 includes the method of Example 14, wherein the device is integrated in the vehicle.

Example 16 includes the method of any of Examples 13 to 15, wherein the error output indicates whether an error associated with the extracted first audio samples is detected.

Example 17 includes the method of any of Examples 13 to 16, wherein the obtained audio samples correspond to feedback from a speaker pad after playout.

Example 18 includes the method of any of Examples 13 to 17, and the method further includes receiving, at a first time, an audio start indication that an initial audio sample of the first audio data has been added to the audio buffer, wherein the audio sample position configuration is based at least in part on receipt of the audio start indication.

Example 19 includes the method of any of Examples 13 to 18, and the method further includes applying a bitmask to the obtained audio samples to extract the first audio samples, wherein the audio sample position configuration is based on the bitmask.

Example 20 includes the method of Example 19, and the method further includes obtaining the bitmask from a register.

Example 21 includes the method of any of Examples 13 to 20, and the method further includes receiving at a second time, an audio end indication that a last audio sample of the first audio data has been added to the audio buffer, wherein the audio sample position configuration is based at least in part on receipt of the audio end indication.

Example 22 includes the method of any of Examples 13 to 21, and the method further includes determining a generated checksum based on the extracted first audio samples; and generating the error output based on a comparison of the generated checksum and a target checksum of a corresponding first set of audio samples of the first audio data.

Example 23 includes the method of any of Examples 13 to 22, and the method further includes transmitting, via a modem, the error output.

Example 24 includes the method of any of Examples 13 to 23, and the method further includes providing the error output to a display device.

According to Example 25, a non-transitory computer-readable medium storing instructions that, when executed by one or more processors, cause the one or more processors to obtain audio samples that are based on buffered audio samples added to an audio buffer, the obtained audio samples including first audio samples interleaved with second audio samples, wherein the first audio samples are based on first audio data corresponding to a safety alert, and wherein the second audio samples are based on second audio data; extract the first audio samples from the obtained audio samples based on an audio sample position configuration associated with the first audio data; and generate an error output based on the extracted first audio samples.

According to Example 26, an apparatus includes means for obtaining audio samples that are based on buffered audio samples added to an audio buffer, the obtained audio samples including first audio samples interleaved with second audio samples, wherein the first audio samples are based on first audio data corresponding to a safety alert, and wherein the second audio samples are based on second audio data; means for extracting the first audio samples from the obtained audio samples based on an audio sample position configuration associated with the first audio data; and means for generating an error output based on the extracted first audio samples.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store first audio data and second audio data, wherein the first audio data corresponds to a safety alert; and
one or more processors coupled to the memory, wherein the one or more processors are configured to:
obtain audio samples that are based on buffered audio samples added to an audio buffer, the obtained audio samples including first audio samples interleaved with second audio samples, wherein the first audio samples are based on the first audio data, and wherein the second audio samples are based on the second audio data;
extract the first audio samples from the obtained audio samples based on an audio sample position configuration associated with the first audio data; and
generate an error output based on the extracted first audio samples.

2. The device of claim 1, wherein the safety alert is associated with one or more components of a vehicle.

3. The device of claim 2, wherein the one or more processors are integrated in the vehicle.

4. The device of claim 1, wherein the error output indicates whether an error associated with the extracted first audio samples is detected.

5. The device of claim 1, wherein the obtained audio samples correspond to feedback from a speaker pad after playout.

6. The device of claim 1, wherein the one or more processors are configured to receive, at a first time, an audio start indication that an initial audio sample of the first audio data has been added to the audio buffer, and wherein the audio sample position configuration is based at least in part on receipt of the audio start indication.

7. The device of claim 1, wherein the one or more processors are configured to apply a bitmask to the obtained audio samples to extract the first audio samples, and wherein the audio sample position configuration is based on the bitmask.

8. The device of claim 7, wherein the one or more processors are configured to obtain the bitmask from a register.

9. The device of claim 1, wherein the one or more processors are configured to receive, at a second time, an audio end indication that a last audio sample of the first audio data has been added to the audio buffer, and wherein the audio sample position configuration is based at least in part on receipt of the audio end indication.

10. The device of claim 1, wherein the one or more processors are configured to:
determine a generated checksum based on the extracted first audio samples; and
generate the error output based on a comparison of the generated checksum and a target checksum of a corresponding first set of audio samples of the first audio data.

11. The device of claim 1, further comprising a modem configured to transmit the error output.

12. The device of claim 1, further comprising a display device configured to display the error output.

13. A method comprising:
obtaining, at a device, audio samples that are based on buffered audio samples added to an audio buffer, the obtained audio samples including first audio samples interleaved with second audio samples, wherein the first audio samples are based on first audio data corresponding to a safety alert, and wherein the second audio samples are based on second audio data;
extracting, at the device, the first audio samples from the obtained audio samples based on an audio sample position configuration associated with the first audio data; and
generating, at the device, an error output based on the extracted first audio samples.

14. The method of claim 13, wherein the safety alert is associated with one or more components of a vehicle.

15. The method of claim 14, wherein the device is integrated in the vehicle.

16. The method of claim 13, further comprising receiving, at a first time, an audio start indication that an initial audio sample of the first audio data has been added to the audio buffer, wherein the audio sample position configuration is based at least in part on receipt of the audio start indication.

17. The method of claim 13, further comprising applying a bitmask to the obtained audio samples to extract the first audio samples, wherein the audio sample position configuration is based on the bitmask.

18. The method of claim 13, further comprising receiving, at a second time, an audio end indication that a last audio sample of the first audio data has been added to the audio buffer, wherein the audio sample position configuration is based at least in part on receipt of the audio end indication.

19. The method of claim 13, further comprising:
determining a generated checksum based on the extracted first audio samples; and
generating the error output based on a comparison of the generated checksum and a target checksum of a corresponding first set of audio samples of the first audio data.

20. A non-transitory computer-readable medium storing instructions that, when executed by one or more processors, cause the one or more processors to:
obtain audio samples that are based on buffered audio samples added to an audio buffer, the obtained audio samples including first audio samples interleaved with second audio samples, wherein the first audio samples are based on first audio data corresponding to a safety alert, and wherein the second audio samples are based on second audio data;
extract the first audio samples from the obtained audio samples based on an audio sample position configuration associated with the first audio data; and
generate an error output based on the extracted first audio samples.
